(19) United States
(12) Patent Application Publication
(10) Pub. No.: US 2016/0074751 A1
(43) Pub. Date: Mar. 17, 2016

(54) VISUAL EFFECTS FOR INTERACTIVE COMPUTER GAMES ON MOBILE DEVICES

(71) Applicant: Palmwin Information Technology (Shanghai) Co. Ltd., Shanghai (CN)

(72) Inventors: Guoqiang Zhang, Nanjing (CN); Zhiguo Deng, Nanjing (CN); Huaichang Zhang, Nanjing (CN)

(21) Appl. No.: 14/699,930

(22) Filed: Apr. 29, 2015

(30) Foreign Application Priority Data
Sep. 15, 2014 (CN) 201410468197.1

(51) Int. Cl. A63F 13/25

(52) U.S. Cl. CPC A63F 13/25

(57) ABSTRACT

A solution is provided to enhance user experience in playing interactive computer games through special visual effects. A communication terminal identifies a visual effect pattern from one or more input data, e.g., audio, video and sensory data associated with a game session, generates and transmits a visual effect command to a receiving communication terminal, which executes the visual effect command to generate the visual effect on the second communication terminal. Each of identified visual effect patterns corresponds to a visual effect command, which is associated with one or more executable computer instructions. The receiving communication terminal determines a visual effect program corresponding to a visual effect command received from the sending communication terminal. The receiving communication terminal executes the visual effect program to generate the corresponding visual effect associated with the game session and displays the visual effect on a display of the receiving communication terminal.

### CROSS REFERENCE TO RELATED APPLICATIONS

This application claims priority under 35 U.S.C. §119(a) from Chinese Patent Application No. 201410468197.1 filed on Sep. 15, 2014, which is hereby incorporated by reference for all purposes as if fully set forth herein.

### BACKGROUND

The disclosure relates generally to mobile Internet technologies, and specifically to generating and displaying visual effects for interactive computer games played on mobile computing devices.

The use of mobile Internet technologies and smart handheld devices, e.g., smartphones and tablet computers, has increased significantly. Various types of computer applications on the mobile computing devices have become increasingly popular. One application is instant communication applications, often provided with video and/or voice call functionality, among other features. The other application is interactive computer games played by multiple players using their respective mobile computing devices, e.g., smartphones.

Various game data and game scenes are generated during an interactive computer game. Existing solutions of interactive computer games generate the game data and/or scenes according to predefined game rules. Game players are given little or no capacity to change the game data and/or scenes generated during game play, which degrades users' interest and experience. For example, users can only make local changes to computer system generated game data and/or game scenes by touching the screens of the mobile computing devices involved in the interactive computer game play. Such interactive computer games are more attractive if the players can become more engaged in the game and/or with other player(s), such as generating special visual effects by one endpoint of the interactive computer game and controlling or modifying the game data presentation on the other endpoint through the generated special visual effects.

### SUMMARY

Embodiments of the disclosure generate a variety of special visual effect commands associated with an interactive computer game played by multiple parties, which enhances the user game playing experience. A first communication terminal generates and transmits a visual effect command to a second communication terminal, which executes the visual effect command and displays the visual effect on the second communication terminal. A visual effect command is one or more executable computer instructions, when executed, generating the corresponding visual effect associated with an interactive computer game. The visual effect command is generated in response to input data received from a variety of input sources of the first communication terminal, including microphone, camera, touchscreen, electronic sensors, etc. From the input data, one or more visual effect patterns are identified. Each of the identified visual effect patterns corresponds to a visual effect command, which generates the identified visual effect on the second communication terminal.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a computing environment for generating and presenting visual effects during an interactive real-time computer game according to one embodiment.

FIG. 2 is a block diagram of a communication terminal for generating visual effect commands during an interactive real-time computer game according to one embodiment.

FIG. 3 is a block diagram of a communication terminal for executing visual effect commands during an interactive real-time computer game according to one embodiment.

FIG. 4 is a block diagram of an exemplary sensor module of a communication terminal according to one embodiment.

FIG. 5 is a flowchart illustrating a process of generating visual effect commands during an interactive real-time computer game according to one embodiment.

FIG. 6 is a flowchart illustrating a process of executing visual effect commands during an interactive real-time computer game according to one embodiment.

FIGS. 7A and 7B illustrate exemplary user interfaces of displaying visual effect on a display of a communication terminal according to an “ADD” visual effect command during an interactive real-time computer game.

FIGS. 8A and 8B illustrate exemplary user interfaces of displaying visual effect on a display of a communication terminal according to a “CHANGE” visual effect command during an interactive real-time computer game.

FIGS. 9A-9D illustrate exemplary user interfaces of displaying visual effect on displays of two communication terminals according to a visual effect command to change the game environment during an interactive real-time computer game.

FIGS. 10A and 10B illustrate exemplary user interfaces of displaying visual effect on a display of a communication terminal according to a “PAUSE” visual effect command during an interactive real-time computer game.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. In particular, for purposes of illustration, a number of embodiments of the invention are illustrated in the context of a game known as bubble shooting. It is understood by a person of ordinary skill in the art that the embodiments of the invention are not limited to any particular game. Reference will now be made in detail to several embodiments, examples of which are illustrated in the accompanying figures. It is noted that wherever practicable similar or like reference numbers may be used in the figures to indicate similar or like functionality.

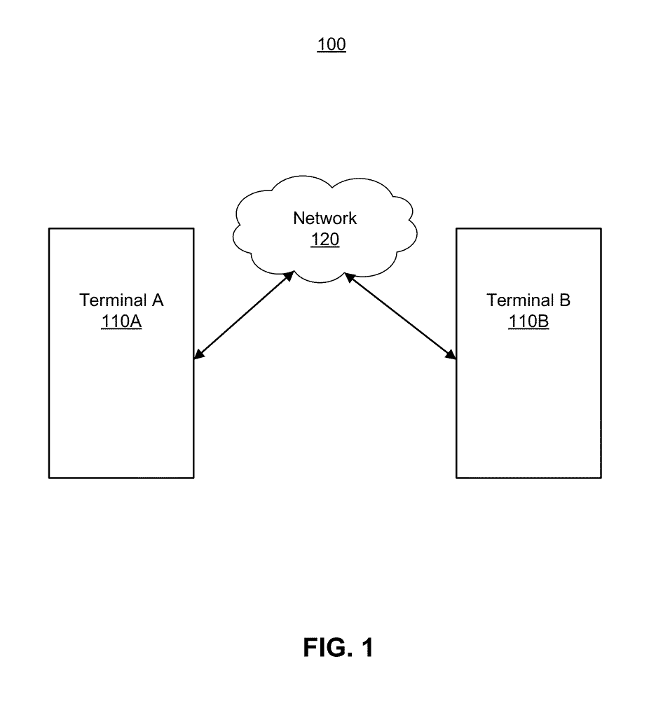

FIG. 1 is a block diagram of a computing environment 100 for generating and executing visual effect commands during an interactive real-time computer game. The computing environment 100 includes a first communication terminal 110A (also referred to as a “first terminal” or “terminal A”) communicating with a second communication terminal 110B (also referred to as a “second terminal” or “terminal B”) over a network 120. Embodiments of the computing environment 100 can have many communication terminals connected to the network 120. Likewise, the functions performed by the communication terminals of FIG. 1 may differ in different embodiments.

In one embodiment, a user of the first terminal 110A plays an interactive computer game, e.g., a bubble shooting game, with a user of the second terminal 110B once a game channel is established. A computer game has one or more special visual effects and a set of predefined commands associated with the special visual effects. In one embodiment, a visual effect command is generated by a first terminal 110A in response to one or more visual effect patterns identified by the first terminal 110A. The first terminal 110A generates the visual effect commands and communicates the visual effect commands and corresponding game data with the player of the second terminal 110B. The second terminal 110B identifies the visual effect command, finds one or more executable computer instructions associated with the visual effect command, executes the instructions and displays the special visual effects on a display of the second terminal 110B.

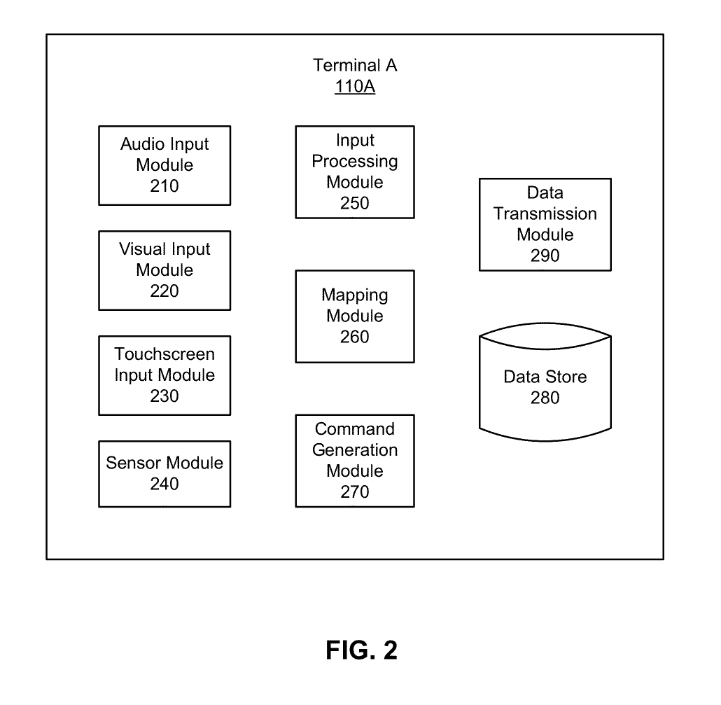

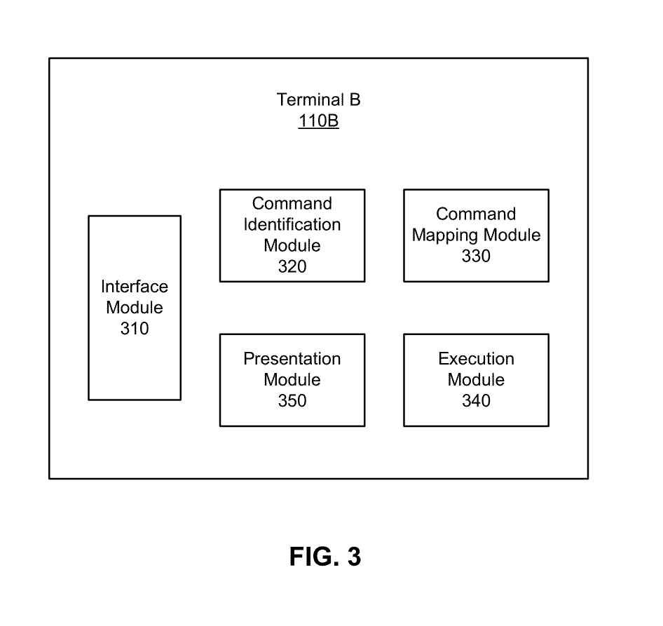

A communication terminal, e.g., the first communication terminal 110A or the second communication terminal 110B, is an electronic device used by a user to perform functions such as communicating and consuming digital media content including video chat, executing software applications, and browsing websites hosted by web servers on the network 120. A communication terminal may be a smart phone, tablet, notebook, desktop computer, or dedicated game console. The communication terminal includes and/or interfaces with a display device on which the user may view the video files and other digital content. In addition, the communication terminal provides a user interface (UI), such as physical and/or on-screen buttons, with which the user may interact with the communication terminal to perform functions such as video chatting, playing a video game, selecting digital content, downloading samples of digital content, and purchasing digital content. The communication terminal may include various input devices to receive input data, e.g., microphone, camera, button, touchscreen, and various sensors. An exemplary communication terminal is described in more detail below with reference to FIGS. 2 and 3.

The network 120 enables communications among the first communication terminal 110A and the second communication terminal 110B and can comprise the Internet as well as wireless communications networks. The network 120 can also include various cellular data networks, such as GSM networks, CDMA networks, and LTE networks. In one embodiment, the network 120 uses standard communications technologies and/or protocols. Thus, the network 120 can include links using technologies such as Ethernet, 802.11, worldwide interoperability for microwave access (WiMAX), 4G, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

In one embodiment, an interactive computer game channel is established between the first communication terminal 110A and the second communication terminal 110B. The computer game may include a real-time video chat function, where two players of the interaction computer game can communicate, e.g., via a video call, while playing the computer game. One or more special visual effects are identified and commands associated with the identified special visual effect patterns are generated and communicated along with corresponding game data between the first terminal 110A and the second terminal 110B. A special visual effect for an interactive video game presents an application of computer graphics to create complex and dynamic images of the interactive video game. A special visual effect command is generated by a first game terminal (e.g., the first terminal 110A) in response to one or more identified visual effect patterns. In one embodiment, a special visual effect is predefined for a particular computer game according to a set of predefined rules. A receiving game terminal (e.g., the second terminal 110B) receives and executes the visual effect command to display one or more visual effects on its display. The visual effect patterns are identified by the first game terminal from the input data it receives. Examples of visual effect patterns identification are described in details with reference to FIG. 2.

A visual effect command specifies what particular actions a receiving game terminal takes to display a special visual effect associated with the command for a game session. A special visual effect command may also include one or more command parameters that specify the details of the visual effect to be displayed, e.g., one or more objects in the game upon which the visual effect command acts. Examples of visual effect commands for a computer bubble shooting game include increasing the rate of bubble generation, changing the directions of bubble movement, changing the light intensity of a background game scene, and pausing and resuming a game session. For simplicity of illustration of an embodiment, the special visual effects identification and special visual effect commands are generated by the first communication terminal 110A; the second communication terminal 110B receives and executes the visual effect commands. For example, after receiving the visual effect command together with other game communication data from the first communication terminal 110A, the second communication terminal 110B identifies the visual effect command, determines a visual effect program corresponding to the identified visual effect command and executes the visual effect program to produce and display the visual effect on its display.

FIG. 2 is a block diagram of a communication terminal for generating visual effect commands during an interactive real-time computer game according to one embodiment. The figure designates the terminal A 110A as a first communication terminal for generating visual effect commands; however, in other embodiments, the terminal B 110B can be a first communication terminal for generating visual effect commands. In a bubble shooting game, the terminal A 110A is the first communication terminal which receives input data from various input sources, identifies visual effect patterns from the received input data, and generates and transmits visual effect commands to the second communication terminal; the terminal B 110B is the second communication terminal, which receives the visual effect commands from the terminal A 110A and executes the commands to generate the visual effect. The second communication terminal is further described with reference to the description of the terminal B 110B in FIG. 3.

In the embodiment illustrated in FIG. 2, the terminal A 110A includes one or more input modules, e.g., an audio input module 210, a visual input module 220, a touchscreen input module 230, and a sensor module 240, an input processing module 250, a mapping module 260, a command generation module 270, a data transmission module 290, and a data store 280. In other embodiments, the terminal A 110A may further include other input modules. The input modules receive different types of input data from various input sources and send the received input data to the input processing module 250 for processing. The input processing module 250 processes the input data and identifies one or more predefined visual effect patterns from the input data. A visual effect pattern may be identified from the input data of an input module; multiple different visual effect patterns can be mapped to a same visual effect command. An input source provides input data captured by an input device of the terminal A 110A, such as a microphone, a camera, a button, a touchscreen, an accelerometer, a gyroscope, a temperature sensor, and a light sensor.

The audio input module 210 receives audio data from an audio acquisition device of the terminal A 110A, such as a microphone embedded with the terminal A 110A. The predefined visual effect patterns identifiable from the audio data from the audio input module 210 may include sound of kissing, sound of crying, sound of laughing, sound of exhaling or inhaling, sound of sneezing, and sound of animal barking. The audio data may also include spoken words corresponding to one or more of predefined sound patterns of excitement, such as sounds for words of “Yeah,” “Whoa,” “Yes” and sounds for loud applauses in the context of interactive computer games. The predefined visual effect patterns include the predefined sound patterns of excitement.

The visual input module 220 receives video or image data from a video acquisition device of the terminal A 110A, such as a camera embedded with the terminal A 110A. The predefined visual effect patterns identifiable from the video/image data from the visual input module 220 may include various facial expressions and body movements, e.g., body gestures representing smiling, kissing, crying, and closing eyes.

The touchscreen input module 230 receives touchscreen input data from a touchscreen of the terminal A 110A. The predefined visual effect patterns identifiable from the touchscreen data from the touchscreen input module 230 may include a number of successive touches on the touchscreen within a predefined period of time, swiping the touchscreen in a predefined trajectory, performing multi-finger operations in a predefined manner, and the like.

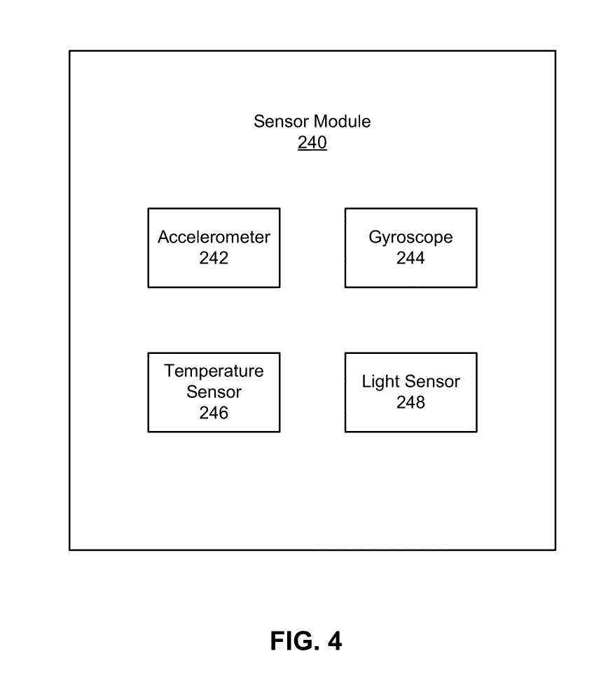

The sensor module 240 includes various electronic sensors, which is further illustrated in detail in FIG. 4. FIG. 4 is a block diagram of the sensor module 240 according to one embodiment. In FIG. 4, the sensor module 240 includes an accelerometer 242, a gyroscope 244, a temperature sensor 246, and a light sensor 248. Other types of sensors can also be included in other embodiments. The accelerometer 242 is an electromechanical device used to measure acceleration forces of an object. The acceleration forces may be static, like the continuous force of gravity or dynamic in response to movement or vibrations of an object, e.g., the movement of the terminal A 110A. The gyroscope 244 is an electronic sensor that measures orientation of an object, e.g., the terminal A 110A. The accelerometer 242 and the gyroscope 244 can be used to detect and determine the movement of the terminal A 110A. The temperature sensor 246 is an electronic sensor that measures temperature of the environment, in which the terminal A 110A is located. The light sensor 248 is an electronic sensor that measures light intensity of the environment, in which the terminal A 110A is located.

Turning back to FIG. 2, the various types of input data received by the input modules are sent to and processed by the input processing module 250. The input processing module 250 continuously monitors the various types of the input data and identifies any visual effect pattern contained in the input data in real-time, including all visual effect patterns mentioned above and their various combinations.

In one embodiment, the input processing module 250 identifies the visual effect patterns in received input data using any suitable schemes known to those of ordinary skill in the art. For example, as mentioned earlier, the visual effect patterns from audio input data may include sound of kissing, sound of crying, sound of laughing, sound of exhaling or inhaling, sound of sneezing, sound of animal barking, and predefined spoken keywords, e.g., “Yes,” “Yah”. Such visual effect patterns can be identified using existing audio recognition algorithms, e.g., using support vectors machines for audio classification. The visual effect patterns from the visual input data may include various facial expressions and body movements, e.g., body gestures representing smiling, kissing, crying, and closing eyes. Such visual effect patterns can be identified using any existing image processing algorithms, e.g., algorithms for facial expression and gesture recognition. The visual effect patterns from the touchscreen input data from the touchscreen input module 230 may include a number of successive touches on the touchscreen within a predefined period of time, swiping the touchscreen in a predefined trajectory, performing multi-finger operations in a predefined manner, and the like. Such visual effect patterns can be identified by using various touchscreen-based motion detection schemes known to those of ordinary skill in the art.

The visual effect patterns identified by the input processing module 250 are further processed by the mapping module 260. The mapping module 260 maps an identified visual effect pattern to a visual effect command according to a set of predefined rules, e.g., as a mapping table stored in the data store 280. The mapping table is loaded to the data store 280 when an interactive computer game is initialized and is available for access during a game session. The mapping table includes mappings between a visual effect pattern and a visual effect command, which, when received by a receiving communication terminal, invokes one or more executable computer instructions to generate a visual effect corresponding to the visual effect command on a receiving communication terminal. For example, in a bubble shooting game played on two communication terminals, a visual effect pattern of the sound of exhaling on a sending communication terminal (e.g., terminal A 110A) corresponds to a visual effect command of “ADD”, which corresponds to a sequence of executable computer instructions that increase the rate of bubble generation on a receiving communication terminal (e.g., terminal B 110B); a visual effect pattern of the sound of inhaling corresponds to a visual effect command of decreasing the rate of bubble generation. In one embodiment, each visual effect pattern is assigned a visual effect identifier and is represented as an integer in the mapping table.

After a visual effect pattern is mapped to a visual effect command, the command generation module 270 generates the visual effect command that is executable by the second communication terminal 110B. A visual effect command may include a plurality of metadata describing various characteristics of the visual effect command, e.g., a timing variable indicating a time period during which the visual effect is to be presented on the second communication terminal's screen. Alternatively, a visual effect command may include the one or more parameters upon which the visual effect command acts. For example, in the bubble shooting game, where a visual effect command is to add more bubbles, the name of the visual effect command is “ADD” and the command may contain two parameters: one is the object of the visual effect command, “Bubble,” and the other parameter is an absolute or relative quantity of the speedup.

The visual effect command generated by the command generation module 270 is transmitted by the data transmission module 290 to the second communication terminal 110B. The data transmission module 290 also transmits all other game data, including the video and audio data communicated between the first and second communication terminals by the two game players engaged in a video chat. In one embodiment, not all input data received by the input modules is transmitted by the data communication module 290. For example, video and audio data associated with a video call while the interactive computer game is being played are transmitted to the second communication terminal 110B regardless whether any visual effect pattern is included in the video and audio data. Other input data, such as the touchscreen operations, sensing data received by any of the sensors described above which do not contain identified visual effect patterns, are not transmitted by the data communication module 290; in other words, only the visual effect command corresponding to the visual effect pattern identified in the input data are transmitted to the second communication terminal 110B by the data communication module 290.

There are different ways to transmit the visual effect commands from the first communication terminal 110A to the second communication terminal 110B. For example, in on embodiment, the visual effect commands are transmitted as independent data packets; in another embodiment, the visual effect commands are embedded in game data packets, which include both the visual effect commands and other game data, e.g., game session data. The game data packets embedding the visual effect commands are generated using an encoding method, which combines the visual effect commands and game data.

FIG. 3 is a block diagram of a communication terminal, e.g., the second communication terminal B 110B, for executing visual effect commands during an interactive real-time computer game according to one embodiment. The second communication terminal 110B receives visual effect commands from the first communication terminal 110A, identifies one or more visual effect commands embedded with game data, maps each visual effect command to one or more predefined executable computer programs corresponding to the visual effect command, and executes the one or more predefined programs to generate the visual effect. In the embodiment illustrated in FIG. 3, the second communication terminal 110B includes an interface module 310, a command identification module 320, a command mapping module 330, an execution module 340, and a presentation module 350. Other embodiments can have different and/or additional modules.

The interface module 310 communicates with the first communication terminal 110A to receive game data and visual effect commands sent by the first communication terminal 110A. The command identification module 320 identifies the visual effect commands received by the interface module 310. In one embodiment, the command identification module 320 parses game data packets received from the first communication terminal 110A to retrieve the visual effect commands embedded in the game data packets according to a set of predefined visual effect command encoding rules.

The command mapping module 330 analyzes an identified visual effect command and determines one or more predefined programs using a mapping table. The mapping table includes mapping information between each defined visual effect command and the one or more predefined executable computer programs for executing the visual effect command. In one embodiment, the mapping table is stored within the command mapping module 330; in other embodiments, it may be at another location of the second communication terminal 110B or may be downloaded from somewhere else during the game session or before the game initialization. The one or more predefined executable computer programs for each identified visual effect command are executed by the execution module 340 to generate visual effect corresponding to the executed visual effect command. The generated visual effect is displayed by the presentation module 350 on a display of the second communication terminal 110B.

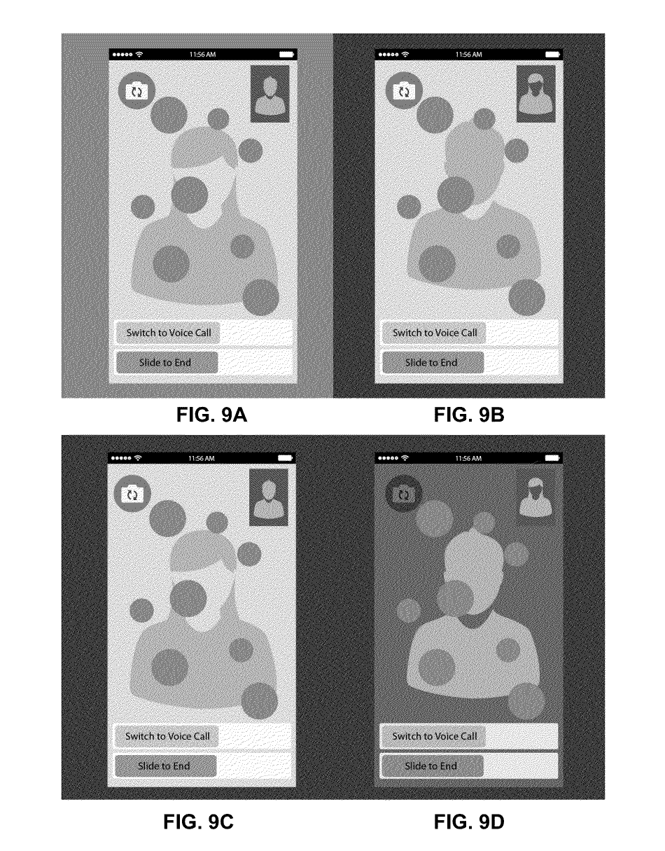

Taking a bubble shooting game as an example, there are two types of visual effect commands. A first type of visual effect command, when executed, presents the visual effect on a receiving communication terminal without changing the game session, e.g., playing an animated icon, playing a sound, or triggering a vibration during the game session. The first type of visual effect command generates a visual effect to be presented on the terminal 110B, but the command does not directly affect any part of the game session and game scene data generation. One example of the first type of visual effect command is illustrated in FIGS. 9A-9D, where the light intensity of the game session background is changed corresponding to a visual effect command. The first type of visual effect command includes a command identifier and one or more command parameters describing various aspect of a visual effect, e.g., a time limit of the visual effect to be presented.

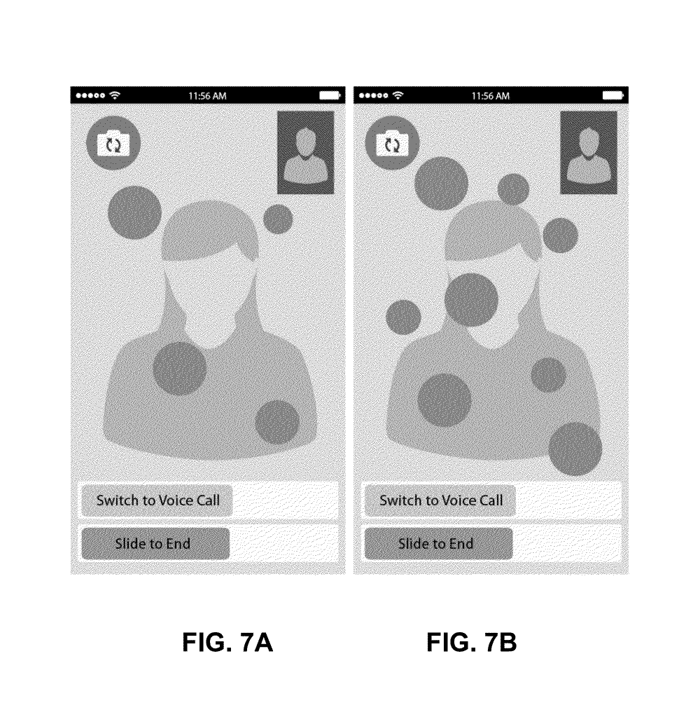

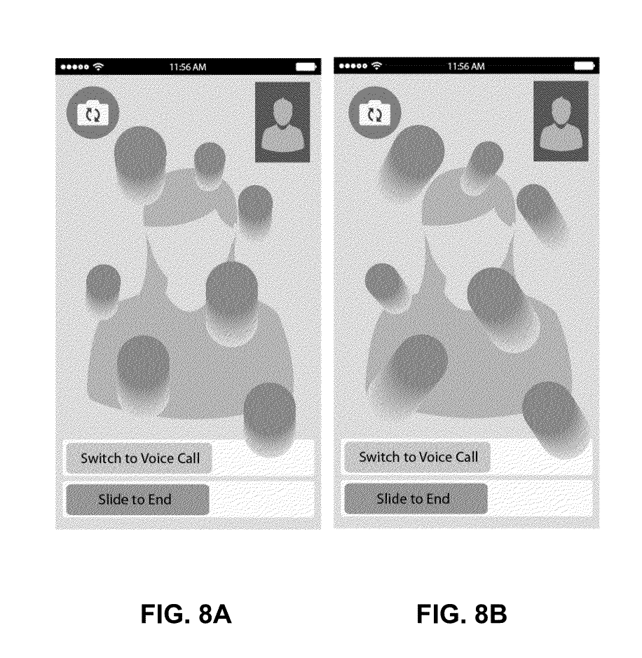

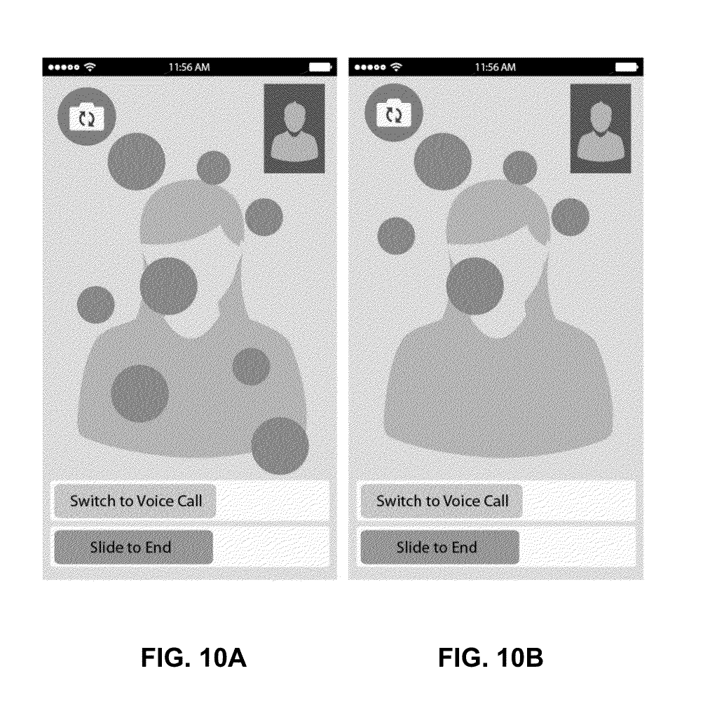

A second type of visual effect command changes the game session during and/or before the presentation of the visual effect on a receiving communication terminal. A visual effect command of the second type, when executed, changes the status data of a game session and/or representation of a game scene. For example, a visual effect command of “ADD” to increase the rate of bubble generation changes the number of bubble generated per unit of time during the game session at a receiving communication terminal, e.g., terminal B 110B. More details of this visual effect command are described with reference to FIGS. 7A and 7B. Another visual effect command, “CHANGE,” that changes the directions of bubble movement presented on the terminal B 110B is described with reference to FIGS. 8A and 8B. Yet another visual effect command that pauses bubble generation during the game session, “PAUSE,” is described with reference to FIGS. 10A and 10B. The second type of visual effect command also includes a command identifier and one or more command parameters, e.g., objects modified by the command, duration of the visual effect and the like.

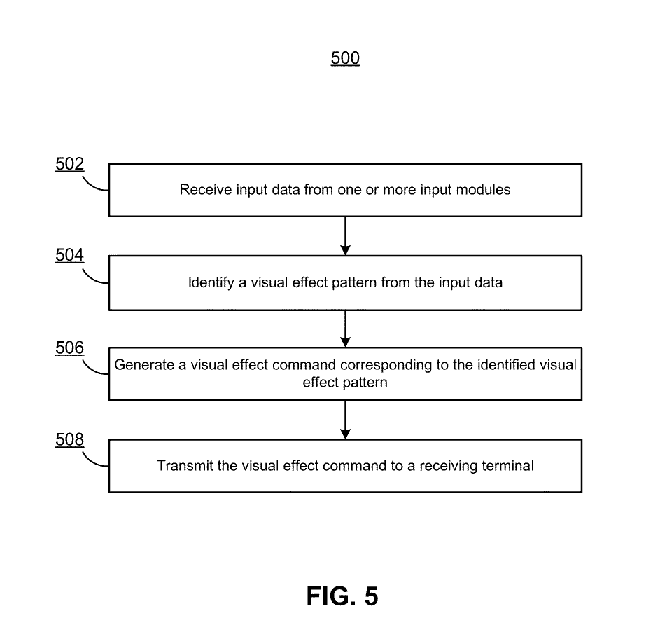

FIG. 5 is a flowchart illustrating a process performed by a communication terminal to generate visual effect commands during an interactive real-time computer game according to one embodiment. Initially, the first communication terminal 110A receives 502 input data from one or more input modules, such as audio input module 210, visual input module 220, touchscreen input module 230, and sensor module 240. The input modules receive different types of input data from various input sources, e.g., audio, video, touchscreen and sensory data associated with the interactive computer game. A visual effect pattern may be identified from the input data of more than one input modules. An input module may be any input device of the terminal A 110A, such as a microphone, a camera, a button, a touchscreen, an accelerometer, a gyroscope, a temperature sensor, and a light sensor.

From the received input data, the first communication terminal 110A identifies 504 one or more predefined visual effect patterns. The visual effect patterns identifiable from the audio input data may include sound of kissing, sound of crying, sound of laughing, sound of exhaling or inhaling, sound of sneezing, sound of animal barking, and one or more predefined spoken keywords. The visual effect patterns identifiable from the video/image input data may include various facial expressions and body movements representing, e.g., smiling, kissing, crying, and closing eyes. The visual effect patterns identifiable from the touchscreen input data may include a number of successive touches on the touchscreen within a predefined period of time, swiping the touchscreen in a predefined trajectory, performing multi-finger operations in a predefined manner, and the like. The visual effect patterns also include sensory data identifiable from the sensory input data.

The first communication terminal 110A generates 506 a visual effect command corresponding to an identified visual effect pattern. In one embodiment, the first communication terminal 110A accesses a mapping table having a mapping between each predefined visual effect pattern and the corresponding visual effect command. The visual effect command is generated according to the mapping information for the identified visual effect pattern. In one embodiment, each visual effect pattern is assigned a visual effect identifier and may be represented as an integer in the mapping table. The first communication terminal 110A transmits 508 the visual effect command to a receiving terminal, i.e., the second communication terminal 110B, using one of a variety of ways, e.g., as an independent data packet, or being embedded with corresponding game data in a game data packet.

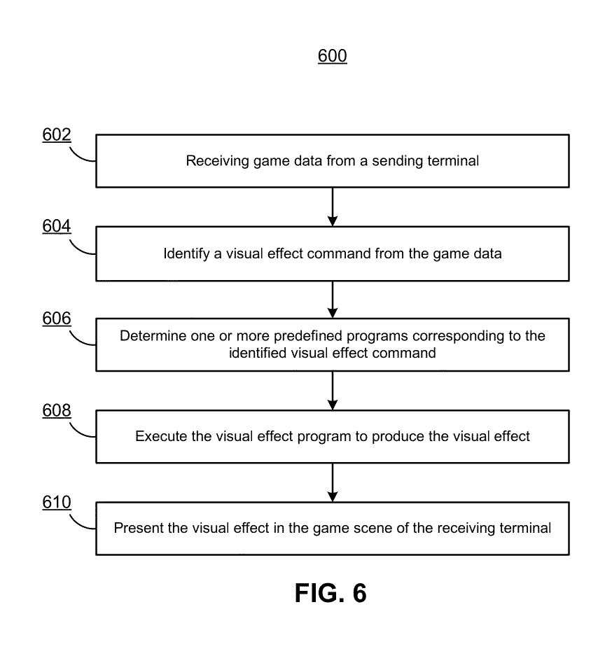

FIG. 6 is a flowchart illustrating a process performed by a communication terminal, e.g., the second communication terminal 110B, to execute visual effect commands during an interactive real-time computer game according to one embodiment. Initially, the second communication terminal 110B receives 602 game data from a sending terminal, i.e., the first communication terminal 110A. The game data includes one or more visual effect commands. The second communication terminal 110B identifies 604a visual effect command from the received game data by parsing the game data to retrieve the visual effect command. The second communication terminal 110B analyzes the identified visual effect command and determines 606 one or more predefined executable computer programs using a mapping table. The mapping table includes mapping information between each defined visual effect command and the one or more predefined executable computer programs for executing the visual effect command. The determined one or more predefined programs are executed 608 to produce the visual effect. In 610, the visual effect is presented on a display of the second communication terminal 110B.

FIGS. 7A and 7B illustrate exemplary user interfaces of displaying visual effect on a display of a communication terminal according to an “ADD” visual effect command during an interactive real-time computer game according to one embodiment. Both FIG. 7A and FIG. 7B show the user interface of the second communication terminal 110B, where FIG. 7A represents the user interface before the visual effect command is executed and the visual effect is presented and FIG. 7B represents the user interface after the visual effect command is executed and the visual effect is presented. In the example illustrated in FIG. 7A and FIG. 7B, the visual effect command is “ADD,” which increases the rate of bubble generation on the second communication terminal 110B during the game session. The visual effect command “ADD” is generated by the first communication terminal 110A in response to the sound of exhaling produced by the player associated with the first communication terminal 110A.

In FIG. 7A, where the visual effect command is not yet executed, there are four bubbles shown on the user interface of the second communication terminal 110B. The game player of the first communication terminal 110A makes a sound of exhaling, which is a predefined visual effect pattern. The sound of exhaling is received and identified by the first communication terminal 110A to be a visual effect pattern. The first communication terminal 110A looks up its mapping table and finds a mapping between the identified visual effect pattern and a visual effect command of increasing the rate of bubble generation on a receiving communication terminal. The first communication terminal 110A generates a visual effect command “ADD” based on the mapping. The visual effect command may include at least two parts: a command identifier, “ADD,” and the objects of the command, i.e., bubbles. The visual effect command may further include a time limit of the visual effect, specifying how long the visual effect will be presented. The first communication terminal 110A transmits the visual effect command to the second communication terminal 110B along with other game data. The second communication terminal 110B identifies the visual effect command “ADD”, finds the corresponding executable program(s) associated with the command, and executes the program(s) to increase the rate of bubble generation for the second communication terminal 110B. After the execution of the visual effect command, as shown in FIG. 7B, the number of bubbles is increased to eight.

FIGS. 8A and 8B illustrate exemplary user interfaces of displaying visual effect on a display of a communication terminal according to a “CHANGE” visual effect command during an interactive real-time computer game implementing visual effects. FIG. 8A and FIG. 8B show the user interface of the second communication terminal 110B before and after the execution of the visual effect command “CHANGE” during a game session. FIG. 8A represents the user interface before the visual effect command “CHANGE” is executed and the visual effect is presented; FIG. 8B represents the user interface after the visual effect command “CHANGE” is executed and the visual effect is presented. The visual effect command “CHANGE” in FIGS. 8A and 8B is to change the directions of bubble movement. The corresponding visual effect pattern is a predefined trajectory of movement of the first communication terminal 110A, e.g., shaking the first communication terminal 110A up and down or side to side, or moving the terminal 110A in a circular manner. This visual effect pattern can be detected and identified from the input data received by the accelerometer 242 and/or the gyroscope 244 of the first communication terminal 110A. The visual effect command “CHANGE” is generated by the first communication terminal 110A according to the identified visual effect pattern. The generated visual effect command may include a command identifier, “CHANGE,” and the objects which the command is applied to, i.e., bubbles. Depending on the trajectory of movement of the first communication terminal 110A, the visual effect command “CHANGE” may further include one or more command parameters specifying the directions of bubble movement on the display of the second communication terminal 110B. After the second communication terminal 110B receives and executes the visual effect command, the directions of bubble movement of the second communication terminal 110B are changed accordingly

FIGS. 9A-9D illustrate exemplary user interfaces of displaying visual effect on displays of two communication terminals according to a visual effect command to change the game environment during an interactive real-time computer game. The visual effect command in the example illustrated in FIGS. 9A-9D is to adjust light intensity of a game scene on the second communication terminal 110B according to the light intensity of a corresponding game scene at the first communication terminal 110A. FIG. 9A illustrates a user interface of the first communicational terminal 110A, where the light intensity of 110A's environment is high. FIG. 9B illustrates the user interface of the second communication terminal 110B when the corresponding first communication terminal 110A is in the environment with high light density (as in FIG. 9A). When the light intensity of the first communication terminal 110A's environment decreases from FIG. 9A to 9C (note that the environment of the first communication terminal 110A is darker in FIG. 9C than in FIG. 9A), a visual effect command is generated by the first communication terminal, sent to the second communication terminal and executed on the second communication terminal 110B to reduce the light intensity of the game background of the second communication terminal 110B. FIG. 9D shows the user interface of the corresponding game scene with a darkened game scene background compared with the one illustrated in FIG. 9B. As a result of the decreased light intensity of the game scene background on the second communication terminal 110B, the difficulty level of the bubble hitting game for the player associated with the second communication terminal 110B is increased.

FIGS. 10A and 10B illustrate exemplary user interfaces of displaying visual effect on a display of a communication terminal according to a “PAUSE” visual effect command during an interactive real-time computer game. FIG. 10A and FIG. 10B show the user interfaces of the second communication terminal 110B before and after executing the visual effect command “PAUSE”. FIG. 10A represents the user interface before the visual effect command “PAUSE” is executed and the visual effect is presented, and FIG. 10B represents the user interface after the visual effect command “PAUSE” is executed and the visual effect is presented. The visual effect command in FIGS. 10A and 10B is to pause the bubble generation on the second communication terminal 110B. The corresponding visual effect pattern is a predefined facial expression of the player of the first communication terminal 110A, e.g., closing eyes. This visual effect pattern can be detected and identified from the input data received by the visual input module 220 of the first communication terminal 110A. The visual effect command is generated by the first communication terminal 110A according to the identified visual effect pattern. The second communication terminal 110B receives and executes the visual effect command to pause the bubble generation on the second communication terminal 110B. As shown in FIGS. 10A and 10B, before the bubble generation is paused, there are eight bubbles in the game scene, whereas after the bubble generation is paused, there are only four bubbles in the game scene.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method generating visual effect commands for a computer game, comprising:
initiating, by a first communication terminal, a computer game between the first communication terminal and a second communication terminal;
receiving a plurality of input data associated with the computer game played by a user on the first communication terminal;
identifying one or more visual effect patterns based on the received input data;
generating a visual effect command for each identified visual effect pattern; and
transmitting the visual effect command to the second communication terminal.

2. The method of claim 1, wherein the plurality of input data associated with the computer game is received from a plurality of data sources and comprises at least one of:
audio data describing sound of the computer game played by the user on the first communication terminal;
video data describing visual features of the computer game played by the user on the first communication terminal;
sensor data describing a plurality of sensor signals associated with the computer game played by the user on the first communication terminal; and
data generated in response to interaction between the user of the first communication terminal and a display interface of the first communication terminal.

3. The method of claim 2, wherein the audio data describing sound of the computer game played by the user on the first communication terminal comprises sounds captured by a microphone of the first communication terminal, the sounds comprising:
a sound of kissing;
a sound of crying;
a sound of laughing;
a sound of exhaling or inhaling;
a sound of sneezing; and
a sound of animal barking.

4. The method of claim 2, wherein the video data describing visual features of the computer game played by the user on the first communication terminal comprises images captured by a digital camera of the first communication terminal, the images describing a plurality of facial gestures of the user of the first communication terminal, comprising:
smiling;
kissing;
crying; and
closing eyes.

5. The method of claim 2, wherein the sensor data describing a plurality of sensor signals associated with the computer game played by the user on the first communication terminal comprises:
temperature information of the environment where the first communication terminal is located;
light intensity of the environment where the first communication terminal is located;
rotation of the first communication terminal captured during the play of the computer game; and
acceleration of the first communication terminal captured during the play of the computer game.

6. The method of claim 2, wherein the data generated in response to interaction between the user of the first communication terminal and a display interface of the first communication terminal comprises:
detection of touching the display interface by the user of the first communication terminal;
detecting of swiping the display interface by the user of the first communication terminal; and
detection of a number of touches of the display interface within a predefined period of time by the user of the first communication terminal.

7. The method of claim 1, wherein identifying a plurality of visual effect patterns based on the received input data comprises:
parsing the received input data to identify the type of the input data; and
identifying a visual effect pattern associated with the type of the input data.

8. The method of claim 1, wherein a visual effect command for an identified visual effect pattern provides information on presenting a plurality of game scenes associated with the computer game at the second communication terminal.

9. The method of claim 8, wherein the information on presenting a plurality of game scenes associated with the computer game at the second communication terminal comprises:
a visual effect command identifier;
a parameter of the computer game that is affected by the visual effect command;
a plurality of parameters associated with the visual effect command; and
a time limit of validity of the visual effect command.

10. The method of claim 8, wherein the visual effect command comprises:
information on increasing a number of objects presented at the second communication terminal;
information on changing directions of objects presented at the second communication terminal;
information on changing light intensity of display of game scenes at the second communication terminal; and
information on decreasing a number of objects presented at the second communication terminal.

11. The method of claim 1, wherein transmitting the visual effect command to the second communication terminal comprises:
encoding the visual effect command into a plurality data packets;
encoding data describing game scenes of the computer game into a plurality data packets; and
transmitting the encoded visual effect command, and data describing the game scenes to the second communication terminal.

12. A computer-implemented method for presenting visual effects associated with a computer game on a second communication terminal, comprising:
receiving, at the second communication terminal, game data from a first communication terminal;
identifying a visual effect command from the received game data;
mapping the visual command to one or more executable computer programs on the second communication terminal;
executing the computer programs; and
presenting a visual effect associated with the visual effect command on the second communication terminal.

13. The method of claim 12, wherein the presenting a visual effect associated with the visual effect command on the second communication terminal comprises:
generating the visual effect based on information associated with the visual effect command; and
presenting the visual effect on a display of the second communication terminal.

14. A computing device, comprising:
a computer processor for executing computer program modules; and
a non-transitory computer readable storage medium storing computer program modules executable to perform steps comprising:
initiating, by a first communication terminal, a computer game between the first communication terminal and a second communication terminal;
receiving a plurality of input data associated with the computer game played by a user on the first communication terminal;
identifying one or more visual effect patterns based on the received input data;
generating a visual effect command for each identified visual effect pattern; and
transmitting the visual effect command to the second communication terminal.

15. The computing device of claim 14, wherein the plurality of input data associated with the computer game is received from a plurality of data sources and comprises at least one of:
audio data describing sound of the computer game played by the user on the first communication terminal;
video data describing visual features of the computer game played by the user on the first communication terminal;
sensor data describing a plurality of sensor signals associated with the computer game played by the user on the first communication terminal; and
data generated in response to interaction between the user of the first communication terminal and a display interface of the first communication terminal.

16. The computing device of claim 15, wherein the audio data describing sound of the computer game played by the user on the first communication terminal comprises sounds captured by a microphone of the first communication terminal, the sounds comprising:
a sound of kissing;
a sound of crying;
a sound of laughing;
a sound of exhaling or inhaling;
a sound of sneezing; and
a sound of animal barking.

17. The computing device of claim 15, wherein the video data describing visual features of the computer game played by the user on the first communication terminal comprises images captured by a digital camera of the first communication terminal, the images describing a plurality of facial gestures of the user of the first communication terminal, comprising:
smiling;
kissing;
crying; and
closing eyes.

18. The computing device of claim 15, wherein the sensor data describing a plurality of sensor signals associated with the computer game played by the user on the first communication terminal comprises:
temperature information of the environment where the first communication terminal is located;
light intensity of the environment where the first communication terminal is located;
rotation of the first communication terminal captured during the play of the computer game; and
acceleration of the first communication terminal captured during the play of the computer game.

19. The computing device of claim 15, wherein the data generated in response to interaction between the user of the first communication terminal and a display interface of the first communication terminal comprises:
detection of touching the display interface by the user of the first communication terminal;
detecting of swiping the display interface by the user of the first communication terminal; and
detection of a number of touches of the display interface within a predefined period of time by the user of the first communication terminal.

20. The computing device of claim 16, wherein a visual effect command for an identified visual effect pattern provides information on presenting a plurality of game scenes associated with the computer game at the second communication terminal.

21. The computing device of claim 20, wherein the information on presenting a plurality of game scenes associated with the computer game at the second communication terminal comprises:
a visual effect command identifier;
a parameter of the computer game that is affected by the visual effect command;
a plurality of parameters associated with the visual effect command; and
a time limit of validity of the visual effect command.

22. The computing device of claim 20, wherein the visual effect command comprises:
information on increasing a number of objects presented at the second communication terminal;
information on changing directions of objects presented at the second communication terminal;
information on changing light intensity of display of game scenes at the second communication terminal; and
information on decreasing a number of objects presented at the second communication terminal.

23. The computing device of claim 14, wherein the computer program modules further executed to perform steps comprising:
encoding the visual effect command and the corresponding visual effect pattern into a plurality data packets;
encoding data describing game scenes of the computer game into a plurality data packets; and
transmitting the encoded visual effect command and data describing the game scenes to the second communication terminal.

24. A non-transitory computer readable medium storing executable computer program instructions, the computer program instructions comprising instructions that when executed cause a computer processor to:
initiate, by a first communication terminal, a computer game between the first communication terminal and a second communication terminal;
receive a plurality of input data associated with the computer game played by a user on the first communication terminal;
identify one or more visual effect patterns based on the received input data;
generate a visual effect command for each identified visual effect pattern; and
transmit the visual effect command to the second communication terminal.

25. The computer readable medium of claim 24, wherein the plurality of input data associated with the computer game is received from a plurality of data sources and comprises at least one of:
audio data describing sound of the computer game played by the user on the first communication terminal;
video data describing visual features of the computer game played by the user on the first communication terminal;
sensor data describing a plurality of sensor signals associated with the computer game played by the user on the first communication terminal; and
data generated in response to interaction between the user of the first communication terminal and a display interface of the first communication terminal.

26. The computer readable medium of claim 24, wherein a visual effect command for an identified visual effect pattern provides information on presenting a plurality of game scenes associated with the computer game at the second communication terminal.

27. The computer readable medium of claim 26, wherein the information on presenting a plurality of game scenes associated with the computer game at the second communication terminal comprises:
a visual effect command identifier;
a parameter of the computer game that is affected by the visual effect command;
a plurality of parameters associated with the visual effect command; and
a time limit of validity of the visual effect command.

28. The computer readable medium of claim 26, wherein the visual effect command comprises:
information on increasing a number of objects presented at the second communication terminal;
information on changing directions of objects presented at the second communication terminal;
information on changing light intensity of display of game scenes at the second communication terminal; and
information on decreasing a number of objects presented at the second communication terminal.
